(19) United States
(12) Patent Application Publication
(10) Pub. No.: US 2012/0250676 A1
(43) Pub. Date: Oct. 4, 2012

(54) VOIP GATEWAY AND METHOD FOR SETTING UP SPEECH COMMUNCIAITON THEREOF

(75) Inventor: KUN-YI WU, Tu-Cheng (TW)

(73) Assignee: HON HAI PRECISION INDUSTRY CO., LTD., Tu-Cheng (TW)

(21) Appl. No.: 13/275,322

(22) Filed: Oct. 18, 2011

(30) Foreign Application Priority Data
Mar. 29, 2011 (CN) 201110076820.5

(51) Int. Cl. H04L 12/66

(52) U.S. Cl. 370/352

(57) ABSTRACT

A Voice over Internet Protocol (VoIP) gateway includes a virtual Session Initiation Protocol (SIP) proxy server, a management and monitoring module, and a virtual SIP phone. The virtual SIP proxy server is configured for registering the at least one of a number of local audio terminals and assigning an internet protocol (IP) address to each of them. When the local phone terminal dials the VoIP phone or receives a call from the VoIP, the management and monitoring module sets up a communication between the local phone terminal and the VoIP phone.

### BACKGROUND

1. Technical Field

The disclosure generally relates to Voice over Internet Protocol (VoIP) gateways, and particularly to a VoIP gateway and method for setting up a speech communication between a local phone terminal and a VoIP phone.

2. Description of Related Art

For a local phone terminal which includes multiple local audio terminals such as a mobile phone, a PDA or a personal computer using wireless communication systems or public switched phone network (PSTN) systems, to share a common phone number with each other during making a call with a VoIP phone, the common phone number need to be assigned to the multiple local audio terminals. The multiple local audio terminals are registered in a common external proxy server in the communication network to connect the multiple local audio terminals with each other. Thus, when a VoIP phone dials the common phone number through the external proxy server, all the registered local audio terminals ring and wait to be picked up. However, registering all the local audio terminals in the external proxy server may increase the workload of the external proxy server.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure

FIG. 1 is a block diagram of a VoIP gateway used to set up a speech communication between a local phone terminal and a VoIP phone, according to an exemplary embodiment.

FIGS. 2 and 3 are a flowchart of a process for using the local audio terminals of the local phone terminal to dial the VoIP phone through the VoIP gateway, according to an exemplary embodiment.

FIGS. 4-6 are a flowchart of a process for using the local audio terminals of the local phone terminal to receive a call from the VoIP phone through the VoIP gateway, according to an exemplary embodiment.

### DETAILED DESCRIPTION

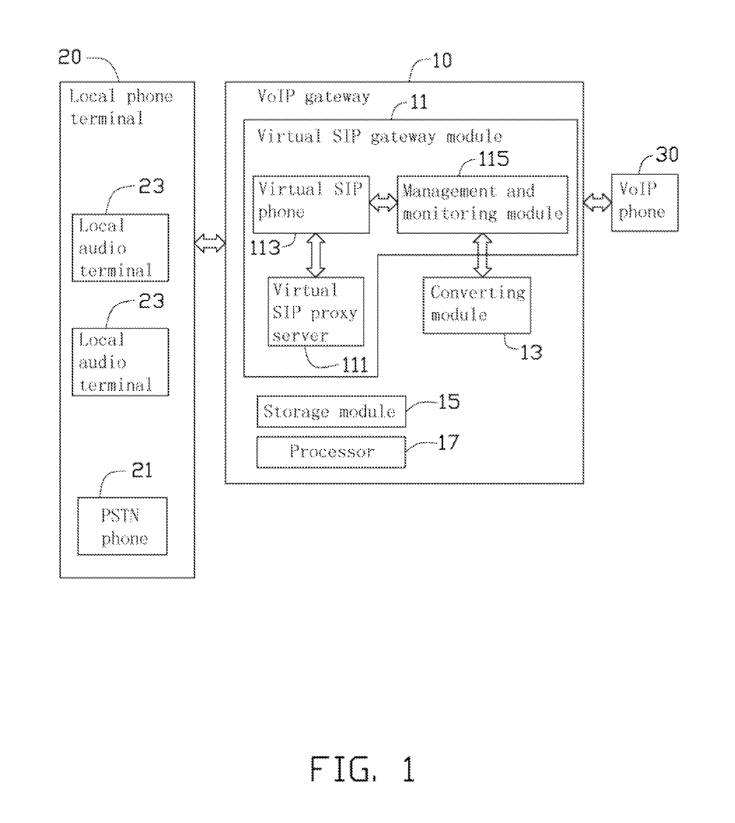

FIG. 1 is a block diagram of a VoIP gateway 10 used to set up a voice communication between a local phone terminal 20 and a VoIP phone 30. The local phone terminal 20 includes a PSTN phone 21 and a plurality of local audio terminals 23. The local audio terminals 23 may be a mobile phone, a PDA or a personal computer, all of which share a common phone number with the PSTN phone.

The VoIP gateway 10 includes a virtual Session Initiation Protocol (SIP) gateway module 11, a converting module 13, a storage module 15 and a processor 17. The virtual SIP gateway module 11, the converting module 13 and the converting module 13 comprise software or programs stored in the storage module 15, and can be executed by the processor 17 to set up a speech communication between the local phone terminal 20 and the VoIP phone 30.

In general, the word “module”, as used herein, refers to logic embodied in hardware or firmware, or to a collection of software instructions written in a programming language, such as, Java, C, or assembly. One or more software instructions in the modules may be embedded in firmware, such as in an EPROM. The modules described herein may be implemented as either software and/or hardware and may be stored in any type of computer-readable medium or other storage device.

The virtual SIP gateway module 11 includes a virtual SIP proxy server 111, a virtual SIP phone 113 and a management and monitoring module 115. The virtual SIP proxy server 111, the virtual SIP phone 113, and the management and monitoring module 115 communicate with each other based on SIP, a real-time transport protocol (RTP), and also a real-time transport control protocol (RTCP).

The virtual SIP proxy server 111 is configured for registering the local audio terminals 23, assigning an IP address to each local audio terminal 23, and recording the particular IP address of the local audio terminal 23 that dials the VoIP phone 30 or is receives a call from the VoIP phone 30. The register is defined as giving the virtual SIP proxy server 111 accounts from the local audio terminals 23 to specify the virtual SIP proxy server 111. Thus, calls made by the local audio terminals 23 will use the account and the associated virtual SIP proxy server 111. When one of the local audio terminals 23 dials the VoIP phone 30, the virtual SIP proxy server 111 receives a first request data packet from the local audio terminal 23, and sends the first request data packet to the VoIP phone 30 by means of the virtual SIP phone 113 and the management and monitoring module 115, and also records the IP address of the local audio terminal 23.

If the VoIP phone 30 is picked up (e.g., answered) within a first preset time period, the virtual SIP proxy server 111 receives a first response data packet from the management and monitoring module 115, and sends the first response data packet to the local audio terminal 23 that dialed the VoIP phone 30, according to the IP address recorded in the virtual SIP proxy server 111. Thus, a speech communication is set up between the VoIP phone 30 and the local audio terminal 23. If the phone 30 is not picked up (e.g., not answered) within the first preset time period, the virtual SIP proxy server 111 receives a first non-response data packet from the management and monitoring module 115, and sends the first non-response data packet to the local audio terminal 23.

When the local phone terminal 20 receives a call from the VoIP phone 30 by means of the VoIP gateway 10 and the PSTN phone 21 rings, the virtual SIP proxy server 111 receives a second request data packet from the VoIP phone 30 through the management and monitoring module 30, and sends the second request data packet to the local audio terminals 23, to ring all of the local audio terminals 23 which are registered in the virtual SIP proxy server 111.

If and when one of the ringing local audio terminals 23 is picked up, the virtual SIP proxy server 111 receives a second response data packet from the particular local audio terminal 23 which is picked up, and sends a second response data packet to the management and monitoring module 115, and also records the IP address of the local audio terminal 23 which was picked up.

The virtual SIP phone 113 is configured for sending data packets such as the first and second request data packets, the first and second response data packets, the first and second non-response data packets and voice data packets transmitted between the local audio terminal 23 and the management and monitoring module 30 by using an IP address of the virtual SIP phone 113. The IP addresses of the virtual SIP proxy server 111 and the virtual SIP phone 113 are assigned by an external proxy server (not shown).

When any one of the local audio terminals 23 dials the VoIP phone 30, the management and monitoring module 115 transmits the first request data packet from the virtual SIP phone 113 to the VoIP phone 30. The management and monitoring module 115 also determines whether the VoIP phone 30 is picked up within the first preset time period. If the VoIP phone 30 is picked up within a first preset time period, the management and monitoring module 115 receives a first response data packet from the VoIP phone 30 and sends the first response data packet to the virtual SIP proxy server 111. In the event that the VoIP phone 30 is not picked up within the specified time, the management and monitoring module 115 also sends the first non-response data packet to the virtual SIP proxy server 111.

When the local phone terminal 20 receives a call from the VoIP phone 30, the management and monitoring module 115 sends the second request data packet to the PSTN phone 21 and rings the PSTN phone 21. Meanwhile, the management and monitoring module 115 determines whether any local audio terminal(s) 23 is registered in the virtual SIP proxy server 111.

If one or more of the local audio terminal(s) 23 is registered in the virtual SIP proxy server 111, the management and monitoring module 115 sends the second request data packet to that local audio terminal 23. That local audio terminal 23 signifies an incoming call and waits to be picked up. Otherwise, if none of the local audio terminals 23 are registered in the virtual SIP proxy server 111, the management and monitoring module 115 further determines whether or not the PSTN phone 21 is picked up within a second preset time period. If the PSTN phone 21 is picked up within the second preset time period, the management and monitoring module 115 sends a third response data packet from the PSTN phone 21 to the VoIP phone 30. If the PSTN phone 21 is not picked up within the second preset time period and if none of the local audio terminals 23 are registered in the virtual SIP proxy server 111, the management and monitoring module 115 sends a second non-response data packet to the VoIP phone 30.

If the registered local audio terminal 23 receive the second request data packet and signifies an incoming call, the management and monitoring module 115 further determines whether the ringing local phone terminal 20 is picked up within a third preset time period.

If one of the ringing local audio terminals 23 is picked up within the third preset time period, the management and monitoring module 115 receives the second response data packet from the local audio terminal 23 which is picked up and sends a second response data packet to the VoIP phone 30. Meanwhile, the management and monitoring module 115 has cancelled the incoming call warning (as ringing or otherwise) being given by the PSTN phone 21 and by any other registered local audio terminals 23.

If none of the ringing local audio terminals 23 is picked up but the PSTN phone 21 is picked up within the third preset time period, the management and monitoring module 115 sends the third response data packet from the PSTN phone 21 to the VoIP phone 30. Meanwhile, the management and monitoring module 115 cancels the ringing or other incoming call warning being given by the local audio terminals 23.

The converting module 13 is configured for converting the data packets transmitted between the PSTN phone 21 and the VoIP phone 30. When the PSTN phone 21 dials the VoIP phone 30, the PSTN phone 21, by means of the converting module 13, sends a third request data packet to the management and monitoring module 115. The management and monitoring module 115 determines the source of the request data packets according to the IP address thereof. If the IP address of the request data packet is that of the virtual SIP phone 113, the management and monitoring module 115 determines that the request data packet has been sent from the local audio terminals 23 through the virtual SIP phone 113. If the IP address of the request data packet is that of the PSTN phone 21, the management and monitoring module 115 determines that the request data packet has been sent from the PSTN phone 21.

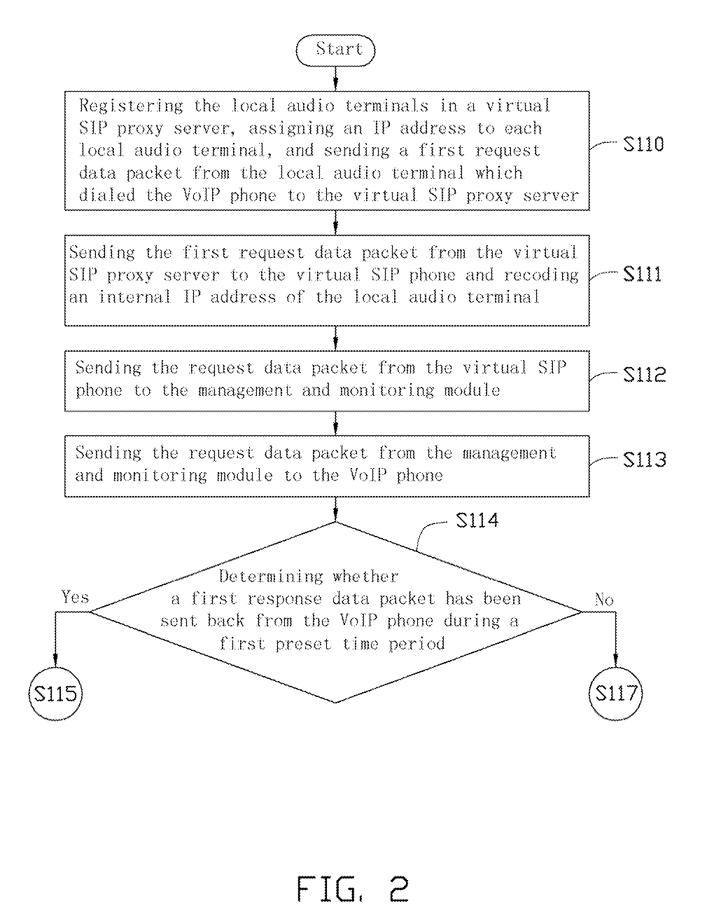

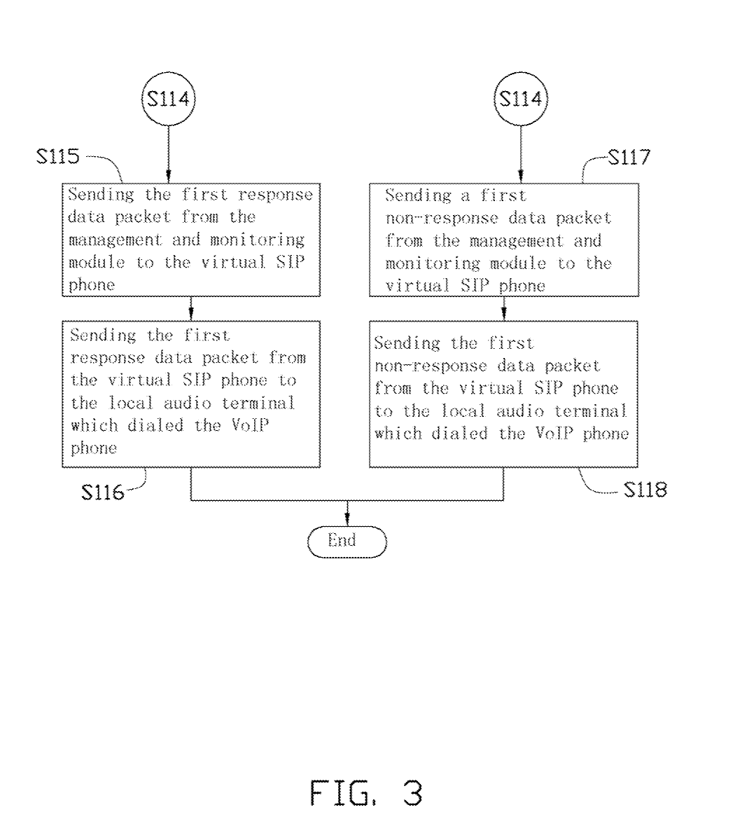

Referring to FIGS. 2-3, a process for using the local audio terminals 23 to dial the VoIP phone 30 through the VoIP gateway 10 may include following steps. Depending on the embodiment, additional or less steps may be added, or the ordering of the steps may be changed.

In step S110, the local audio terminals 23 are registered in the virtual SIP proxy server 111, and the virtual SIP server proxy server 111 assigns an IP address for each of the local audio terminals 23. Any one of the local audio terminals 23 may send a first request data packet to the virtual SIP proxy server 111.

In step S111, the virtual SIP proxy server 111 receives the first request data packet, records the IP address of the local audio terminal 23 which sent it, and sends the first request data packet to the virtual SIP phone 113.

In step S112, the virtual SIP phone 113 sends the first request data packet to the management and monitoring module 115 by using an IP address thereof.

In step S113, the management and monitoring module 115 sends the first request data packet to the VoIP phone 30.

In step S114, the management and monitoring module 115 determines whether a first response data packet has been sent back from the VoIP phone 30 within a first preset time period. If not, the process goes to step S117, but if a first response data packet is sent back from the VoIP phone 30 within the first preset time period, the process goes to step S115.

In step S115, the management and monitoring module 115 sends the first response data packet to the virtual SIP phone 113 and the process goes to step S 116.

In step S116, the virtual SIP phone 113 sends the first response data packet to the local audio terminal 23 which sent the first request data packet, according to the internal IP address recorded by the proxy server 111. Thus, a speech communication is set up between the local audio terminal 23 and the VoIP phone 30.

In step S117, the management and monitoring management 115 sends a first non-response data packet to the virtual SIP phone 113 and the process goes to step S118.

In step S118, the virtual SIP phone 113 sends the first non-response data packet to the local audio terminal 23 which, according to the internal IP address recorded by the virtual SIP proxy server 111, sent the first request data packet.

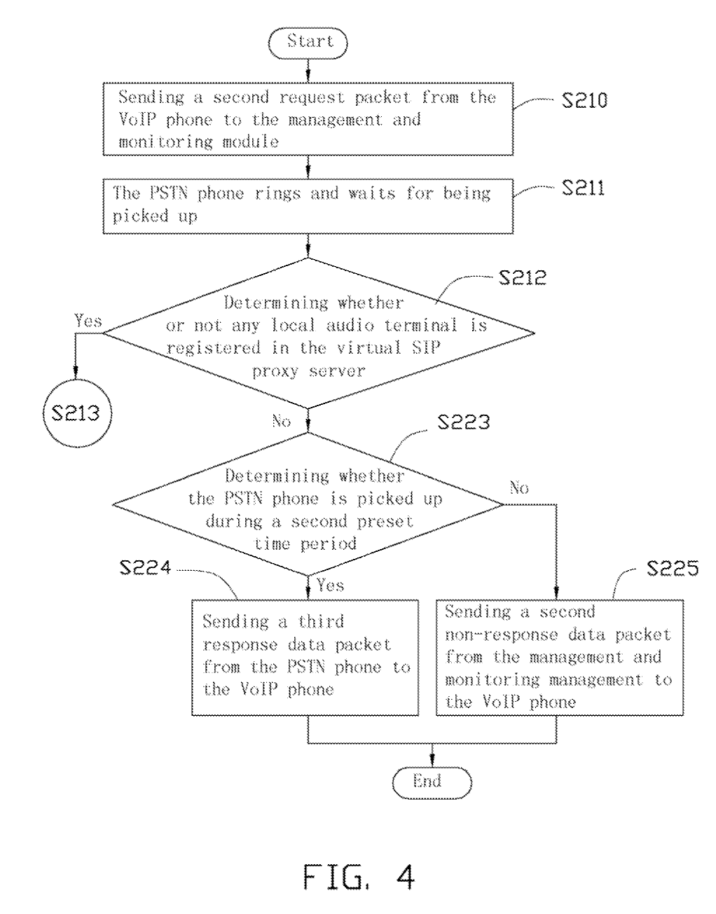

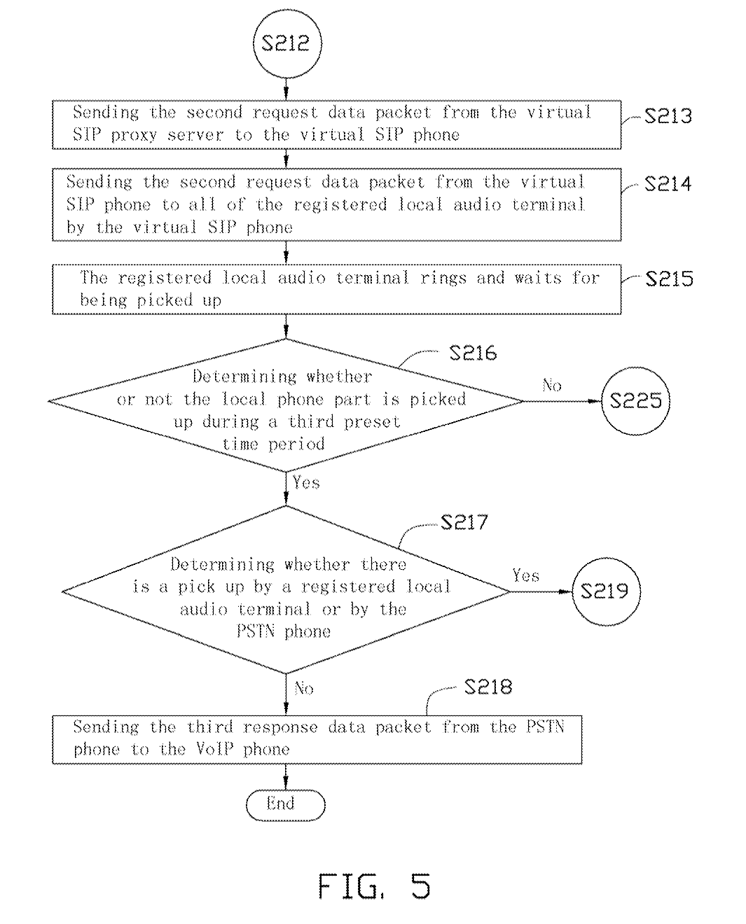

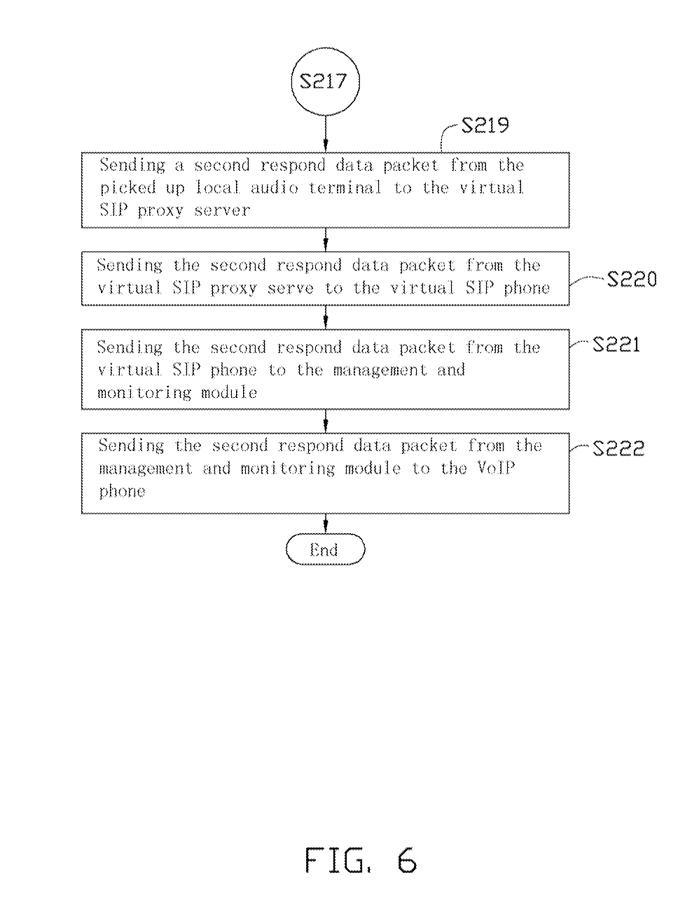

Referring to FIGS. 4-6, a process for using the local audio terminals 23 to receive a call from a VoIP phone 30 may include following steps. Depending on the embodiment, additional or less steps may be added and the ordering of the steps may be changed.

In step S210, the VoIP phone 30 sends a second request packet to the management and monitoring module 115 for setting up a speech communication with the local phone terminal 20.

In step S211, the management and monitoring module 115 sends the second request packet received from the VoIP phone to the converting module 13. The converting module 13 converts the second request packet to an analog signal and sends the analog signal to the PSTN phone 21. The PSTN phone 21 rings and waits to be picked up.

In step S212, the management and monitoring module 115 determines whether or not any local audio terminal is registered in the virtual SIP proxy server 111. If one or more of the local audio terminal is registered in the virtual SIP proxy server 111, the process goes to step S213, if not the process goes to step S223.

In step S213, the management and monitoring module 115 sends the second request data packet to the virtual SIP phone 113, and the process goes to step S214.

In step S214, the virtual SIP phone 113 sends the second request data packet to all of the registered local audio terminals 23

In step S215, all of the registered local audio terminals 23 ring and wait to be picked up.

In step S216, the management and monitoring module 115 determines whether or not the local phone terminal 10 is picked up within a third preset time period. If any one of the registered local audio terminal(s) 23 or the PSTN phone 21 is picked up within the preset time period, the process goes to step S217, if not the process goes to step 225.

In step S217, the management and monitoring module 115 determines whether there is a pick up by a registered local audio terminal(s) 23 or by the PSTN phone 21. If a registered local audio terminal 23 is picked up, the process goes to step S219. If the PSTN phone 21 is picked up, the process goes to step S218.

In step S218, the management and monitoring module 115 sends the third response data packet from the PSTN phone 21 to the VoIP phone 30 to set up the speech communication between the PSTN phone and the VoIP phone 30, and cancels the call notification by the local audio terminals 23.

In step S219, one or more of the local audio terminals 23 has been picked up and sends a second respond data packet to the virtual SIP proxy server 111.

In step S220, the virtual SIP proxy server 111 sends the second respond data packet to the virtual SIP phone 113, and records the IP address of the local audio terminal 23 which was picked up and sent the second respond data packet.

In step S221, the virtual SIP phone 113 sends the second respond data packet to the management and monitoring module 115.

In step S222, the management and monitoring module 115 sends the second respond data packet to the VoIP phone 30 to set up the speech communication between the local audio terminal 23 and the VoIP phone 30, and cancels the incoming call notification being issued or sounded by the PSTN phone 21 and the other registered local audio terminals 23, and the process ends.

In step S223, the management and monitoring module 115 determines whether or not the PSTN phone 21 has been picked up within a second preset time period. If the PSTN phone 21 is picked up within the period, the process goes to step S224, if not the process goes to step S225.

In step S224, the management and monitoring module 115 sends a third response data packet from the PSTN phone 21 to the VoIP phone 30, and the process ends.

In step S225, the management and monitoring module 115 sends a second non-response data packet to the VoIP phone 30, and the process ends.

Therefore, the local audio terminals 23 can all share a single phone number with the PSTN phone 21 and offer a voice communication function with the VoIP phone 30 through the VoIP gateway 10. Thus, the need to individually register every one of the local audio terminals 23 in an external proxy server is avoided, and the load on the external proxy server can be reduced.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A method for setting up speech communication between a local phone terminal and a Voice over Internet Protocol (VoIP) phone, the local phone terminal comprising a public switched telephone network (PSTN) phone and at least one local audio terminal, the method comprising:
registering the at least one local audio terminal in a virtual Session Initiation Protocol (SIP) proxy server, and assigning an internet protocol (IP) address to each one of the at least one local audio terminal;
sending a first request data packet from one of the at least one local audio terminal to the virtual SIP proxy server;
recording the IP address of the at least one local audio terminal that sent the first request data packet;
sending the first request data packet to the VoIP phone and ringing the VoIP phone;
receiving a first response data packet from the VoIP phone;
sending the first response data packet to the at least one local audio terminal that sent the first request data packet according to the recorded IP address.

2. The method of claim 1, further comprising determining whether a first response data packet has been sent back from the VoIP phone within a first preset time period, and sending the first response data packet to the at least one local audio terminal according to the recorded IP address if the first response data packet is sent back from the VoIP phone within the first preset time period.

3. The method of claim 1, further comprising sending a first non-response data packet to the local audio terminal that sent the first request data packet to the VoIP phone according to the recorded IP address if the first data packet is not sent from the VoIP phone within the first preset time period.

4. A method for setting up a speech communication between a local phone terminal and a Voice over Internet Protocol (VoIP) phone, the local phone terminal comprising a public switched telephone network (PSTN) phone and at least one local audio terminal, the method comprising:
registering the at least one local audio terminal in a virtual Session Initiation Protocol (SIP) proxy server, and assigning an internet protocol (IP) address to each one of the at least one local audio terminal;
receiving a second request data packet from the VoIP phone to the virtual SIP proxy server;
sending the second request data packet to the registered at least one local audio terminals to ring the registered at least one local audio terminals;
sending a second response data packet to the VoIP phone if one of the registered local audio terminals is picked up.

5. The method of claim 4, further comprising sending the second request data packet to ring the PSTN phone after receiving the second request data packet from the VoIP phone.

6. The method of claim 5, further comprising determining whether or not any local audio terminal is registered in the virtual SIP proxy server, if none of the local audio terminal is registered in the virtual SIP proxy server, further determining whether the PSTN phone is picked up within a second preset time period.

7. The method of claim 6, further comprising sending a second non-response data packet to the VoIP phone if the PSTN phone is not picked up within the second preset time period.

8. The method of claim 6, further comprising sending a third response data packet to the VoIP phone if the PSTN phone is picked up within the second preset time period.

9. The method of claim 5, further comprising determining whether or not any local audio terminal is registered in the virtual SIP proxy server, if one or more of the local audio terminal is registered in the virtual SIP proxy server, sending the second request data packet to all of the registered local audio terminals to ring the registered local audio terminals.

10. The method of claim 9, further comprising determining whether the ringing local phone terminal is picked up within a third preset time period after ringing the registered at least one local audio terminals, and further determining whether the local audio terminal or the PSTN phone is picked up.

11. The method of claim 10, further comprising sending a third response data packet from the PSTN phone to the VoIP phone if the PSTN phone is picked up.

12. The method of claim 10, further comprising sending the second response data packet from the picked up registered local audio terminals to the VoIP phone if a registered local audio terminal is picked up.

13. A Voice over Internet Protocol (VoIP) gateway in electronic communication with a local phone terminal, and a VoIP phone, wherein the local phone terminal includes a public switched telephone network (PSTN) phone and at least one local audio terminal, the VoIP gateway comprising:
a storage module;
a processor; and one or more programs stored in the storage module and the programs executed by the processor, the one or more programs comprising:
a virtual Session Initiation Protocol (SIP) proxy server configured for registering the at least one local audio terminal, assigning an internet protocol (IP) address to each of the at least one local audio terminal and recording the IP address of the at least one local audio terminal that dialed the VoIP phone or receives a call from the VoIP phone;
a management and monitoring module transmitting data packets between the local phone terminal and the VoIP phone, when the at least one local phone terminal dials the VoIP phone or receives a call from the VoIP phone, the management and monitoring module setting up a speech communication between the at least one local phone terminal and the VoIP phone, according to the IP address recorded in the virtual SIP proxy server; and
a virtual SIP phone sending data packets from the local phone terminal and the VoIP phone to the management and monitoring module.

14. The VoIP gateway of claim 13, further comprising a converting module configured for converting the data packets transmitted between the PSTN phone and the VoIP phone.

15. The VoIP gateway of claim 13, wherein when one of the one of the local audio terminals dials the VoIP phone, the virtual SIP proxy server receives a first request data packet from the local audio terminal, sends the first request data packet to the VoIP phone by the virtual SIP phone and the management and monitoring module, and recodes the IP address of the local audio terminal that dials the VoIP phone.

16. The VoIP gateway of claim 15, wherein the management and monitoring module determines whether the VoIP phone is picked up within the first preset time period, if the VoIP phone is picked up within a first preset time period, the management and monitoring module sends a first response data packet from the VoIP phone to the virtual SIP proxy server, the virtual SIP proxy server sends the first response data packet to the local audio terminal that dials the VoIP phone to set up the speech communication.

17. The VoIP gateway of claim 16, wherein if the VoIP phone is not picked up within the first preset time period the management and monitoring module sends a first non-response data packet to the virtual SIP proxy server, the virtual SIP proxy server sends the first response data packet to the local audio terminal that dialed the VoIP phone. The virtual SIP phone sends data packets from the local phone terminal and the VoIP phone to the management and monitoring module.
